(19) United States
(12) Patent Application Publication
(10) Pub. No.: US 2018/0312777 A1
(43) Pub. Date: Nov. 1, 2018

(54) NOVEL PROCESS FOR SEPARATING AND PURIFYING COMPONENTS IN TALL OIL FATTY ACIDS

(71) Applicant: Ingevity South Carolina, LLC, North Charleston, SC (US)

(72) Inventor: Bing Wang, Mount Pleasant, SC (US)

(21) Appl. No.: 15/963,660

(22) Filed: Apr. 26, 2018

Related U.S. Application Data
(60) Provisional application No. 62/491,692, filed on Apr. 28, 2017.

(51) Int. Cl. C11C 1/02; C11C 1/00

(52) U.S. Cl. CPC C11C 1/02; C11C 1/005; C11C 1/007

(57) ABSTRACT

The present disclosure provides an efficient process for separating components of tall oil fatty acids (TOFA) and for purifying TOFA from rosin. The process includes mixing TOFA with a novel solvent system containing urea to form urea clathrates, resulting in separation of saturated fatty acids from unsaturated ones and rosin from TOFA by utilizing proper urea to TOFA ratio.

### BACKGROUND

### 1. Field of the Discovery

The present disclosure relates to a method of separating and purifying tall oil fatty acids. Particularly, the disclosure provides methods for tall oil fatty acid separation, including separation of saturated from unsaturated fatty acids, mono-unsaturated from poly-unsaturated fatty acids, and rosin acids from fatty acids.

### 2. Background Information

The Kraft process is the dominant method for producing wood pulp and tall oil is a by-product of the wood pulping process. After the digestion of wood chips, the wood pulp is sent for papermaking; the by-product, black liquor, is the source for crude tall oil (CTO).

At the refineries, CTO is separated by distillation to produce heads, tall oil fatty acids (TOFA), distillated tall oil (DTO), tall oil rosin (TOR), and tall oil pitch (TOP). The most commonly used portions of the separation are TOFA and TOR, applied in the fields such as adhesive, ink, rubber, paper sizing, metal working fluid, asphalt, oilfield chemical and as surfactants. As expected, the TOFA portion of the distillate contains 1-10% rosin and the rosin portion contains various levels of TOFA. Further purification can be done by distillation, but with high energy cost and significant product loss. DTO is a complex mixture of mainly fatty acids and rosin acids

In addition to various amount of rosin components, TOFA from the refineries also contains fatty acid components with different chain lengths and levels of unsaturation. TOFA typically contains palmitic acid, stearic acid, oleic acid, elaidic acid, conjugated and non-conjugated linoleic acid, and linolenic acid. For many applications, it is desirable to separate saturated fats such as palmitic and stearic acid from unsaturated ones, and it would be more desirable to separate mono-unsaturated fats, such as oleic acid and elaidic acid, from poly-unsaturated fats, such as linoleic acid and linolenic acid.

Distillation has been the main technique in separating the components of CTO, utilizing the boiling point discrepancy of rosin and TOFA. However, many fatty acids have very similar boiling points, and therefore, the higher the TOFA purity is required, the more demanding the equipment and distillation conditions are and it is at the expense of higher energy utilization and longer batch time and yield loss of TOFA.

Other known methods such as winterization, adsorption, and urea clathrate complexation all have difficulties that prevent them from being economically feasible for scale up.

Winterization is a method of utilizing different freezing points in fatty acids for separation. This is not an efficient process even with the aid of organic solvents as it suffers from low yields and high cooling energy cost. Moreover, multi-step processing is often needed in order to get one component separated from the rest of fatty acids.

Adsorption separation is another popular method, based on the different adsorbing properties in a mixture of chemicals on the adsorbent. Adsorption method, usually involves high temperature and high pressure treatment and purification but reuse of the adsorbent could be difficult, which makes the scale up cost prohibitive. In addition, it also has limited success in separating TOFA components.

Urea inclusion complexation was originally utilized for petroleum product separation. It has also been applied in fatty acid separation. It has been demonstrated that urea clathrate separation is a more efficient method for TOFA separation, particularly for separating saturated fats from unsaturated ones. However, the separation of TOFA with urea clathrates with commonly-used solvents, such as methanol, ethanol, and chloroform is only partially successful. For example, in U.S. Patent Application Publication No. 2014/0081037 methanol was used as solvent and the best one pass separation for fatty acid esters were palmitic 5% and stearic 1.5% after fractionation.

Other methods for rosin reduction in TOFA have been explored, for example, U.S. Pat. No. 2,538,103 describes a method of separating fatty acids from rosin by reacting rosin selectively with maleic anhydride, followed by distillation to remove unreacted TOFA. This method is not energy efficient and leaves maleated rosin as a distillation bottom, which is cumbersome to remove.

Therefore, there exists a need in the art for better TOFA separation and purification methods.

### SUMMARY

The present description relates to novel processes of separating and purifying tall oil fatty acids (TOFA). The process separates saturated from unsaturated fatty acids, mono-unsaturated from multi-unsaturated fatty acids, and rosin acids from fatty acids.

Thus, an aspect of the present disclosure provides a novel and efficient process to separate or purify different components in a TOFA mixture, and/or to purify TOFA from rosin, wherein the process comprises: mixing the fatty acids mixture with a urea solution comprising an alcohol (e.g. methanol, ethanol or isopropanol) and acetonitrile to form a TOFA-urea complex as a filter cake (precipitate) and a filtrate; separating filtrate from filter cake; processing the filtrate by washing with acidic water to recover unsaturated fatty acids and/or rosins; and processing the filter cake to recover saturated fatty acids.

In an additional aspect, the present disclosure provides a process of separating or purifying the components of tall oil fatty acid (TOFA) mixture, e.g., a crude tall oil mixture, a distilled tall oil (DTO) mixture, or a TOFA/rosin mixture, the process comprising: mixing the fatty acids mixture with a urea solution comprising an alcohol (e.g. methanol, ethanol or isopropanol) and acetonitrile to form a TOFA-urea complex as a filter cake (precipitate) and a filtrate; separating filtrate from filter cake; processing the filtrate by washing with acidic water; processing the filter cake to recover saturated fatty acids; mixing the processed filtrate again with urea solution to form a TOFA-urea complex as a filter cake (precipitate) and a filtrate; separating filtrate from the filter cake; reprocessing the filtrate by washing with acidic water to recover di-fatty acids and rosins; and reprocessing the filter cake to recover mono-unsaturated fatty acids.

In any of the embodiments, urea clathrates are formed with a solvent system and tuned urea to TOFA ratio. The methods described herein provide for the nearly complete separation of saturated fatty acids from unsaturated ones, and rosin from TOFA in a simple and easy to scale up process. As an added benefit, the rosin-free TOFA has significant color reduction vs. the original rosin-containing TOFA.

In any of the embodiments, the components of TOFA mixture are saturated fatty acids, mono-unsaturated fatty acids, bi-unsaturated fatty acids and rosins.

In some embodiments, the saturated fatty acids are at least one of stearic acid, palmitic acid, or a combination thereof.

In certain embodiments, the unsaturated fatty acids are at least one of oleic acid, non-conjugated linoleic acid, Conjugated-linoleic acid, or a combination thereof.

In certain additional embodiments, the saturated fatty acids are separated from mono-unsaturated, bi-unsaturated fatty acids and poly-unsaturated fatty acids.

In any of the embodiments, the saturated fatty acids, mono-unsaturated fatty acids and poly-unsaturated acids are removed sequentially.

In certain embodiments, tall oil fatty acids are separated from rosins.

In some embodiments, urea is recovered from the aqueous phase for reuse.

In certain embodiments, acetonitrile and alcohol are in a ratio from about 1:10 to about 10:1 and urea to solvent are in ratio from about 1:1 to about 1:10.

In some specific embodiments, alcohol is methanol.

In certain additional embodiments, urea to TOFA ratio is about 10:1 to about 0.5:1.

In certain embodiments, urea to TOFA ratio is about 4:1 to about 2:1.

In certain additional embodiments, urea to TOFA ratio in various steps of the process are about 0.5:1 and about 2:1 respectively.

In certain embodiments, urea solution is prepared by heating at a temperature of 50-70° C.

In certain embodiments, wherein TOFA or distilled tall oil is selected from the group consisting of Altapyne™ L-5, Altapyne™ M-28B, Altapyne™ 1483, Altapyne™ L-1, Altapyne™ M-15, Altapyne™ M-38, and Altapyne™ M-50B.

### DETAILED DESCRIPTION

The following is a detailed description provided to aid those skilled in the art in practicing the present disclosure. Those of ordinary skill in the art may make modifications and variations in the embodiments described herein without departing from the spirit or scope of the present disclosure. All publications, patent applications, patents, figures and other references mentioned herein are expressly incorporated by reference in their entirety.

Presently described are methods of producing/making a mixture of fatty acids, such as tall oil fatty acids (TOFA), with reduced/decreased amounts or levels of saturated fatty acids (e.g., stearic acid, palmitic acid, or a combination thereof), as well as methods that utilize the treated fatty acids with reduced amounts of saturated fatty acids.

Where a range of values is provided, it is understood that each intervening value, to the tenth of the unit of the lower limit unless the context clearly dictates otherwise (such as in the case of a group containing a number of carbon atoms in which case each carbon atom number falling within the range is provided), between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either both of those included limits are also included in the invention.

The following terms are used to describe the present disclosure. Unless otherwise defined, all technical and scientific terms used herein have the same meaning as commonly understood by one of ordinary skill in the art to which this disclosure belongs. The terminology used in the description is for describing particular embodiments only and is not intended to be limiting of the invention.

The articles “a” and “an” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

As used herein in the specification and in the claims, the phrase “at least one,” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, in certain methods described herein that include more than one step or act, the order of the steps or acts of the method is not necessarily limited to the order in which the steps or acts of the method are recited unless the context indicates otherwise.

As used herein in the specification and in the claims, alcohol includes but is not limited to methanol, ethanol and isopropanol.

The present disclosure provides an efficient and cost effective process of separating and purifying tall oil fatty acids (TOFA). The process separates saturated from unsaturated fatty acids, mono-unsaturated from poly-unsaturated fatty acids, and rosin acids from fatty acids.

It has long been the goal of pine chemical industry to separate the unsaturated fatty acids from the saturated ones and to separate rosin from TOFA, in order to create high value individual fatty acid components.

An aspect of the present disclosure provides a novel and efficient process to separate different components in a TOFA mixture, and/or to purify TOFA from rosin. In this method, urea clathrates are formed with a novel solvent system and proper urea to TOFA ratio, and as result, saturated fats can be completely separated from unsaturated ones and rosin can be separated from TOFA in a simple and easy to scale up process. As an added benefit, the rosin-free TOFA has significant color reduction as compared to the original rosin-containing TOFA.

Recently it was found that acetonitrile is a unique and useful solvent to separate various components of tall oil fatty acids (U.S. provisional application No. 62/406,537). Surprisingly and unexpectedly, if commonly used solvents are combined such as an alcohol, e.g., methanol, ethanol or isopropanol, with acetonitrile in the urea clathrate process, a more efficient separation of components of TOFA has been observed. In fact, with the use of proper urea and solvent combination, saturated fats can be separated from the unsaturated ones. This kind of TOFA separation efficiency has not been achieved in any of the presently known methods.

Even more surprising, when sufficient urea:solvent ratios were applied, rosin was completely separated from TOFA. As an added benefit, it was found that the rosin-free TOFA has a much lower color (2.3) than the original TOFA (6.5) before treatment as determined using ASTM D1544 or Standard Test Method for Color of Transparent Liquids (Gardner Color Scale). As per the knowledge and understanding of the field, this method is more efficient than presently known methods for both rosin separation from tall oil fatty acids as well as saturated fatty acid separation from unsaturated ones.

Thus, in one aspect, the present disclosure provides a process of separating the components of tall oil fatty acid (TOFA) mixture, e.g., crude or distilled tall oil, and/or TOFA/rosin mixtures. In an exemplary embodiment, the process comprises the steps of: mixing the fatty acids mixture (or distilled tall oil or rosin) with a urea solution comprising an alcohol and acetonitrile to form urea-TOFA complex as a filter cake (precipitate) and a filtrate; separating filtrate from filter cake by passing over a filter producing a filtrate and a filter cake; and processing the filtrate with acidic water (or electrolyzed water) to recover unsaturated TOFA and/or rosins (depending upon TOFA:urea solution ratio); processing the filter cake to recover saturated TOFA.

In certain embodiments, the method further includes a step of recovering urea from the aqueous phase for reuse.

In some embodiments, the urea-TOFA complex is prepared by dissolving urea in acetonitrile and alcohol solution. The ratio of acetonitrile to alcohol can be from 1:10 to 10:1 (e.g., 5:10 to 10:1, 1:1 to 10:1, 2.5:1 to 10:1, 7.5:1 to 10:1, 1:10 to 7.5.1, 5:10 to 7.5:1, 1:1 to 7.5:1, 2.5:1 to 7.5:1, 10:1 to 5:1, 5:10 to 5:1, 1:1 to 5:1, 2.5:1 to 5:1, 10:1 to 7.5:1, or 7.5:10 to 10:1); and urea to solvent (acetonitrile-alcohol) ratio from 1:1 to 1:10. In certain embodiments, the ratio of urea to solvent in the reaction mixture is from about 1:1.5 to 1:5. To facilitate the formation of a clear solution of acetonitrile and alcohol and dissolution of urea in the solvent, the mixture can be heated. Suitable temperatures to which the solvent and urea can be mixed include, but are not limited to, from about 45° C. to about 70° C., from about 50° C. to about 65° C. The tall oil can be combined with the urea solution at an elevated temperature (i.e., a hot urea/ethanol solution) to form the complex. Optionally, the tall oil is degassed and/or heated prior to combining the oil with the hot urea solution. The tall oil is mixed with the urea solution and the combined mixture is allowed to cool to form the solid urea/oil complex. The TOFA/urea complex is cooled down to a temperature from about 10 to about 30° C., more typically from about 15 to about 25° C.

In certain embodiments, the disclosed methods include the step of separating the urea-TOFA (filter cake) complex and removing the filtrate to separate unsaturated and saturated fatty acids to form a dried urea-oil complex (also referred to as a urea “cake”). In additional embodiments, the filter cake is washed with acetonitrile and dried.

In certain embodiments, the filter cake is dissolved in water and heated to a temperature from about 50 to about 80° C., more preferably from about 60 to about 70° C. To facilitate the phase separation, in certain embodiments, toluene is added. After separation of two layers with separatory funnel, vacuum stripping produced saturated free fatty acids substantially free of solvent.

Unless the context indicates otherwise, the term “substantially free of solvent” can mean that the dried oil complex contains less than about 1 wt. %, less than about 0.5 wt. %, or less than about 0.1 wt. % solvent. The solvent can be removed under vacuum. Suitable temperatures for performing the solvent removal include, but are not limited to, from about 4° C. to about 60° C., preferably from about 10° C. to about 22° C. In other examples, the solvent can be removed at about 5° C., about 10° C., about 15° C., about 20° C., about 25° C., about 30° C., about 35° C., about 40° C., about 45° C., about 50° C., about 55° C., or about 60° C., where any of the stated values can form an upper and/or lower endpoint of a range.

In certain embodiments, the filtrate was vacuum stripped to residue oil and toluene-acidic water (pH about 4 adjusted by dilute sulfuric acid) at a filtrate to toluene-acid water ratio of about 10:1 to about 1:1, from about 5:1 to about 2:1 or about 2:1 to form two layers. The aqueous layer may be separated out as urea containing solution, and the toluene layer may be stripped to get unsaturated TOFA-rich product.

In certain embodiments, the aqueous phase collected from filtrate and filter cake processing step are combined and vacuum stripped to recover urea to be reused. Optionally, the process can further include extracting the aqueous layer with an organic solvent prior to evaporating the water from the aqueous layer.

In certain embodiments, the aqueous solution containing used urea is heated from about 40 to about 60° C. or about 50° C. and washed with hexanes at least once but preferably two or more times and is vacuum stripped in an oven at temperature of about 70 to about 150° C. or about 100° C. The recovered solid urea may then be used again. The urea recovered after evaporating the water can be at least about 95% pure, at least about 96% pure, at least about 97% pure, at least about 98% pure, or at least about 99% pure.

At least 85% of the urea used in the initial urea/oil complex can be recovered according to the methods described herein. In some embodiments, at least about 90% of the urea used in the urea-oil complex can be recovered. For example, about 85%, about 86%, about 87%, about 88%, about 89%, about 90%, about 91%, about 92%, about 93%, about 94%, about 95%, about 96%, about 97%, about 98%, or about 99% of the urea can be recovered, where any of the stated values can form an upper and/or lower endpoint of a range.

The urea recovered according to the methods described herein (referred to as “recovered urea”) can be combined with tall oil mixture and used in subsequent urea-oil complexation steps. Optionally, the amount of urea lost during the process can be supplemented by additional urea. In some examples, the recovered urea is supplemented by about 15% or less, about 10% or less, or about 5% or less additional urea. The urea recovered according to these methods can be recycled ten or more times using the methods described herein. The recovered urea can be broken up before being used in the next complexation process.

In another aspect, the present disclosure provides a process of separating or purifying the components of tall oil fatty acid (TOFA) and rosin mixture, the process comprising: mixing the fatty acids mixture with a urea solution comprising an alcohol and acetonitrile in a ratio sufficient to separate a complex of saturated fatty acids in the filter cake (or precipitate) from all other components in the filtrate; separating filtrate from filter cake; processing filter cake to recover saturated fatty acids; processing the filtrate with acidic water (or electrolyzed water) to recover the oil mixture; mixing the oil mixture (from filtrate) with urea solution to form urea-TOFA complex as a filter cake (precipitate) and a filtrate; separating filter cake from the filtrate; reprocessing the filtrate with acidic water (or electrolyzed water) to recover di-unsaturated fatty acids and rosins and reprocessing the filter cake to recover di-unsaturated fatty acids.

In certain embodiments, the method comprises an additional step of recovering urea from the aqueous phase for reuse.

In any of the embodiments, the components of TOFA are saturated fatty acids, mono-unsaturated fatty acids, bi-unsaturated fatty acids, poly-unsaturated fatty acids and rosin acids.

In some of the embodiments, the saturated fatty acids of the process comprise at least one of stearic acid, palmitic acid, or a combination thereof.

In certain embodiments of the process, the unsaturated fatty acids are at least one of oleic acid, non-conjugated linoleic acid, Conjugated-linoleic acid, or a combination thereof.

In any of the embodiments, saturated fatty acids are separated from unsaturated fatty acids.

In any of the embodiments, the saturated fatty acids, mono-unsaturated fatty acids and poly-unsaturated acids are removed sequentially.

In certain embodiments, rosin or rosin acids are separated from TOFA in the filtrate based on TOFA:urea ratio.

In certain additional embodiments, acetonitrile and the alcohol, e.g., methanol, ethanol, or isopropanol are in a ratio from about 1:10 to about 10:1. For example: the ratio of acetonitrile to alcohol is about 5:1 to about 9:1, about 6:1 to about 8:1, or about 7:1.

In some specific embodiments, alcohol is methanol.

In other embodiments, urea to solvent ratio is from about 1:1 to about 1:10. For example: the ratio of urea to solvent is about 1:2 to about 1:8, about 1:2 to about 1:6, or about 1:4.

In further embodiments, a ratio of urea to TOFA is about 10:1 to about 0.5:1. For example, the ratio of urea to TOFA is about 4:1 to about 2:1, about 1.5:1 to about 3:1, about 1:1 or about 1.25:1 or about 0.5:1.

In other embodiments, the process further comprises, after adding the urea solution to the tall oil or TOFA, cooling the mixture. For example, the mixture may be cooled at about −10° C. to about 15° C. or to about −10° C. to about 15° C. In certain embodiments, the mixture is cooled at or to about −10° C. to about 15° C., about −10° C. to about 10° C., about −10° C. to about 5° C., about −10° C. to about 0° C., about −10° C. to about −5° C., about −5° C. to about 15° C., about −5° C. to about 10° C., about −5° C. to about 5° C., about −5° C. to about 0° C., about 0° C. to about 15° C., about 0° C. to about 10° C., about 0° C. to about 5° C., about 5° C. to about 15° C., about 5° C. to about 10° C., or about 10° C. to about 15° C.

In certain embodiments, isolating the treated fatty acids, e.g. an unsaturated fatty acids portion of the fatty acid mixture, can comprise filtering the cooled mixture to separate a precipitate, wherein the treated unsaturated fatty acids are present in the filtrate. Filtering can be performed with any suitable known method/filter. For example, a coarse filter, a medium filter, or a fine filter, such as a fritted funnel, may be utilized. Filtering can be performed at about −10° C. to about 15° C. In certain embodiments, filtering is performed at about −10° C. to about 15° C., about −10° C. to about 10° C., about −10° C. to about 5° C., about −10° C. to about 0° C., about −10° C. to about −5° C., about −5° C. to about 15° C., about −5° C. to about 10° C., about −5° C. to about 5° C., about −5° C. to about 0° C., about 0° C. to about 15° C., about 0° C. to about 10° C., about 0° C. to about 5° C., about 5° C. to about 15° C., about 5° C. to about 10° C., or about 10° C. to about 15° C.

In additional embodiments, a yield of the unsaturated fatty acids is at least about 50%, at least about 65% (e.g., at least about 75%, at least about 80% or at least about 90%).

In additional embodiments, a yield of the saturated fatty acids is at least about 50%, at least about 65% (e.g., at least about 75%, at least about 80%, or at least about 90%).

In certain embodiments, a yield of rosin is at least about 50%, at least about 65% (e.g., at least about 75%, at least about 80%, or at least about 90%).

In certain embodiments, the urea solution is prepared by heating at a temperature of about 50 to about 70° C.

In an embodiment, the fatty acids mixture is selected from the group consisting of TOFA (e.g., TOFA from the Kraft process), vegetable oil, mineral oil, rapeseed oil, coconut oil, palm oil, corn oil, sunflower seed oil, soya oil, linseed oil, or a combination thereof.

In certain embodiments, the TOFA or tall oil mixture is selected from the group consisting of Altapyne™ L-5, Altapyne™ M-28B, Altapyne™ 1483, Altapyne™ L-1, Altapyne™ M-15, Altapyne™ M-38, and Altapyne™ M-50B (Ingevity, South Carolina, USA).

In any of the embodiments, Tall oil is a by-product of the wood pulping and is usually recovered from pine wood “black liquor” of the Kraft paper process. Tall oil contains about equal amount of fatty acids and rosin acids. The fatty acids include palmitic, stearic, oleic, elaidic, and linoleic acids. Rosin acids, such as abietic acid, are monocarboxylic acids comprising three fused six-membered carbon rings, which accounts for the much larger molecular diameter of rosin acids as compared to fatty acids. Some other components also appear in the typical commercial TOFA product, such as unsaponifiables, oligomers and other colored impurities.

### EXAMPLES

### Example 1

50 g urea and 100 ml methanol were heated to 50° C. till a clear solution was obtained then 100 ml acetonitrile was added and continually heated until it was clear again (up to 65° C.).

Then, to the urea/methanol-acetonitrile solution, 40 g Ingevity Altapyne L-5 (or other TOFA product) was added to the above clear solution.

White or light yellow precipitate was seen and it was cooled to 25° C. for 30 minutes. The suspension was filtered and washed with additional 200 ml acetonitrile. The filtrate was vacuum stripped to residue oil and 100 ml toluene/50 ml acidic water (pH about 4 adjusted by dilute sulfuric acid) added to form two layers. The aqueous layer was separated out as urea containing solution and toluene layer was stripped to get unsaturated TOFA-rich product (20 g ca. 50% recovery)

The filter cake was dissolved in 100 ml water and it was heated to 60° C. The saturated fatty acids were on top and can be separated from the aqueous layer. To facilitate phase separation, 50 ml toluene can be added and separated with separatory funnel and vacuum stripped to give saturated free fatty acids. The aqueous phase was combined with previous aqueous phase and was vacuum stripped to recover urea to be reused.

The separation results are summarized in Table 1. All the filtrate data was from vacuum stripping of the solvent and all the filter cake data was after water wash and toluene extraction, followed by vacuum stripping of the solvent.

TABLE 1
Separation result using 5:4 urea:TOFA on Altapyne L-5.

| | | | | % Non- | % | | % |
|---|---|---|---|---|---|---|---|
| | % | % | % | conjugated | Conjugated- | TOFA | Rosin |
| GC data | Palmitic | Stearic | Oleic | linoleic | linoleic | yield | content |
| Altapyne | 5.42 | 1.84 | 37.51 | 29.38 | 8.76 | | 7.25 |
| L-5 | | | | | | | |
| Processed | 0.13 | 0.08 | 18.12 | 45.52 | 10.05 | 50% | 8.64 |
| filtrate (5/4) | | | | | | | |
| Processed | 11.33 | 3.84 | 54.82 | 12.5 | 8.04 | 50% | 1.25 |
| filter cake | | | | | | | |
| (5/4) | | | | | | | |

It was observed that filtrate contains very little palmitic and stearic acid and all the saturated fats have been separated from unsaturated ones. The recovery was about 50/50 on the filter cake vs. filtrate.

### Example 2

The above aqueous solution containing used urea was heated to 50° C. and washed with 2×50 ml hexanes and was vacuum stripped in a 100° C. oven (20 mmHg) for 2 hours. This recovered solid urea was used again for TOFA separation with urea to TOFA ratio of 1:1. The results are summarized in Table 2.

TABLE 2
Separation result using recycled urea with 1:1 urea:TOFA on Altapyne L-5.

| | | | | % | | | |
|---|---|---|---|---|---|---|---|
| | | | | Non- | % | | % |
| GC | % | % | % | conjugated | Conjugated- | TOFA | Rosin |
| data | Palmitic | Stearic | Oleic | linoleic | linoleic | yield | content |
| Altapyne | 5.42 | 1.84 | 37.51 | 29.38 | 8.76 | | 7.25 |
| L-5 | | | | | | | |
| Processed | 0.16 | 0.09 | 24.99 | 43.16 | 6.3 | 62% | 7.33 |
| filtrate (1/1) | | | | | | | |
| Processed | 19.82 | 7.22 | 51.43 | 6.07 | 8.72 | 22% | 1.72 |
| filter cake | | | | | | | |
| (1/1) | | | | | | | |

### Example 3

Same procedure as example 1, except using 2:1 urea:TOFA.

TABLE 3
Separation result using 2:1 urea vs TOFA on Altapyne L-5.

| | | | | % | % | | |
|---|---|---|---|---|---|---|---|
| | | | | Non- | Con | | % |
| GC | % | % | % | conjugated | jugated- | TOFA | Rosin |
| data | Palmitic | Stearic | Oleic | linoleic | linoleic | yield | content |
| Altapyne L-5 | 5.42 | 1.84 | 37.51 | 29.38 | 8.76 | | 7.25 |
| Processed | 0.09 | 0 | 1.28 | 46.9 | 9.14 | 29% | 26.35 |
| filtrate (2/1) | | | | | | | |
| Processed filter | 7.36 | 2.49 | 50.22 | 21.79 | 8.88 | 71% | 2.16 |
| cake (2/1) | | | | | | | |

This particular ratio and process resulted in the filtrate which is mostly free of saturated fats with a significant reduction in oleic acid and less TOFA yield, which means with the increasing urea ratio, mono-unsaturated fats have also been removed in filtrate along with rosins.

### Example 4

Same procedure as example 1, except using 4:1 urea:TOFA.

TABLE 4
Separation result using 4:1 urea:TOFA on Altapyne L-5.

| | | | | % Non- | % | | % | |
|---|---|---|---|---|---|---|---|---|
| GC | % | % | % | conjugated | Conjugated- | TOFA | Rosin | Gardner |
| data | Palmitic | Stearic | Oleic | linoleic | linoleic | yield | content | Color |
| Altapyne | | | | | | | | |
| L-5 | 5.42 | 1.84 | 37.51 | 29.38 | 8.76 | | 7.25 | 6.5 |
| Processed | | | | | | | | |
| filtrate | 0.45 | 0 | 1.9 | 19.34 | 5.28 | 15% | 36.32 | |
| (4/1) | | | | | | | | |
| Processed | | | | | | | | |
| filter cake | 6.49 | 2.19 | 45.0 | 28.66 | 9.19 | 85% | 0% | 2.3 |
| (4/1) | | | | | | | | |

It was observed that with increasing urea to TOFA ratio to 4:1, the filtrate was also practically free of saturated fats and both mono-unsaturated and di-unsaturated fats were also trapped in urea.

Surprisingly, it was found that filter cake contains most of the separation (85%) and it is free of rosin. This means the size of rosin is too big to fit in the cake structure of urea clathrate. This gives a unique way of separating rosin from TOFA. In addition, it was observed that the color of the processed filter cake to be Gardner 2.3, which is significant lower than the original L-5 color of 6.5.

### Example 5

Same procedure as example 1, except using 0.5:1 urea:TOFA in step 1, followed by treating the filtrate again with 2:1 urea:filtrate ratio in step 2. The goal was to remove saturated fatty acids first, followed by mono-unsaturated fatty acids removal and leave only di-saturated fatty acids such linoleic acids.

TABLE 5
Separation result using 0.5:1 urea:TOFA,
followed by 2:1 urea:filtrate obtained from step 1.

| | | | | % Non- | % | | % |
|---|---|---|---|---|---|---|---|
| GC | % | % | % | conjugated | Conjugated- | TOFA | Rosin |
| data | Palmitic | Stearic | Oleic | linoleic | linoleic | yield | content |
| Altapyne L-5 | 5.42 | 1.84 | 37.51 | 29.38 | 8.76 | | 7.25 |
| Processed | 1.32 | 0.12 | 36.20 | 34.90 | 8.23 | 72.5% | 9.69 |
| filtrate (0.5/1) | | | | | | | |
| Processed filter | 13.22 | 5.26 | 39.95 | 19.65 | 8.32 | 27.5% | 5.43 |
| cake (0.5/1) | | | | | | | |
| reprocessed | 0.06 | 0.15 | 0.7 | 15.41 | 17.33 | 25.0% | 42.73 |
| filtrate (2/1) | | | | | | | |
| reprocessed | 2.05 | 0.13 | 56.97 | 22.76 | 8.76 | 75.0% | 1.82 |
| filter cake (2/1) | | | | | | | |

The two-step process showed that saturated fatty acids can be separated in the first step and mono-unsaturated fatty acid (oleic acid) can be removed in the second step, leaving substantially only di-unsaturated fatty acids in the filtrate.

### Example 6

Same procedure as example 4, except using 3/1 urea vs. DTO.

TABLE 6
Separation result using 3/1 urea vs DTO on Altapyne M-28B

| | | | | % Non- | % | | % | |
|---|---|---|---|---|---|---|---|---|
| GC | % | % | % | conjugated | Conjugated- | TOFA | Rosin | Gardner |
| data | Palmitic | Stearic | Oleic | linoleic | linoleic | yield | content | Color |
| Altapyne | 3.44 | 1.2 | 24.7 | 18.42 | 6.67 | | 30.51 | 6.6 |
| M-28B | | | | | | | | |
| Processed | 0.05 | 0.06 | 5.22 | 13.10 | 3.52 | 45% | 68.25 | |
| filtrate | | | | | | | | |
| (3/1) | | | | | | | | |
| Processed | 6.15 | 2.23 | 43.08 | 24.14 | 9.17 | 55% | 8.1 | 4.2 |
| filter cake | | | | | | | | |
| (3/1) | | | | | | | | |

It was observed that with 3/1 urea vs. DTO, the filtrate was practically free of saturated fats, reduced mono-unsaturated and di-unsaturated fats and with 68.25% rosin. The filter cake resembled L-5 in terms of fatty acids and rosin (8.1%) contents and color was reduced to 4.2. The yield was lower for the filter cake vs. similar urea ratio for L-5 separation, maybe due to excess rosin and other impurities in DTO.

### REFERENCES

The following references are incorporated herein by reference in their entirety.

1. Process for the continuous fractionation of a mixture of fatty acids U.S. Pat. No. 5,243,046 A
2. Method for separating saturated and unsaturated fatty acid esters and use of separated fatty acid esters

### 3. US 20090199462 A1

4. Process for separating saturated and unsaturated fatty acids U.S. Pat. No. 8,003,813 B2

### 5. Separation of Saturated/Unsaturated Fatty Acids JAOCS, 1984, 61, 219

6. Process for separating esters of fatty acids by selective adsorption U.S. Pat. No. 4,049,688 A
7. Increase in the Linolenic Acid Content by Solvent Winterization of Fungal Oil Extracted from Mortierella Genus, JAOCS, 1990, 67, 846

1. A process of separating the components of tall oil fatty acid (TOFA) mixture or a TOFA/rosin mixture, the process comprising:
mixing the fatty acids mixture with a urea solution comprising an alcohol and acetonitrile to form a TOFA-urea complex as a filter cake (precipitate) and a filtrate;
separating filtrate from filter cake;
washing the filtrate with acidic water to recover unsaturated fatty acids and/or rosins; and
processing the filter cake to recover saturated fatty acids.

2. The process of claim 1, wherein the TOFA mixture comprises a crude tall oil mixture or a a distilled tall oil (DTO) mixture.

3. The process of claim 1, wherein the components of TOFA mixture are saturated fatty acids, mono-unsaturated fatty acids, bi-unsaturated fatty acids and rosins.

4. The process of claim 1, wherein at least one of:
the saturated fatty acids are at least one of stearic acid, palmitic acid, or a combination thereof;
unsaturated fatty acids are at least one of oleic acid, non-conjugated linoleic acid, Conjugated-linoleic acid, or a combination thereof; or
combinations thereof.

5. The process of claim 1, wherein at least one of:
saturated fatty acids are separated from mono-unsaturated, bi-unsaturated fatty acids and poly-unsaturated fatty acids;
saturated fatty acids, mono-unsaturated fatty acids and poly-unsaturated acids are removed sequentially;
tall oil fatty acids are separated from rosins;
urea is recovered from the aqueous phase for reuse; or
combinations thereof.

6. The process of claim 1, wherein acetonitrile and alcohol are in a ratio from about 1:10 to about 10:1 and urea to solvent ratio from 1:1 to 1:10.

7. The process of claim 1, wherein urea to TOFA ratio is about 10:1 to about 0.5:1.

8. The process of claim 1, wherein urea to TOFA ratio is about 4:1 to about 2:1.

9. The process of claim 1, wherein urea solution is prepared by heating at a temperature of 50-70° C.

10. The process of claim 1, wherein the alcohol is at least one of methanol, ethanol, isopropanol or a combination thereof.

11. A process of separating the components of tall oil fatty acid (TOFA) mixture or TOFA/rosin mixture, the process comprising:
mixing the fatty acids mixture with a urea solution comprising an alcohol and acetonitrile to form a TOFA-urea complex as a filter cake (precipitate) and a filtrate;
separating filtrate from filter cake;
washing the filtrate with acidic water;
processing the filter cake to recover saturated fatty acids;
mixing the processed filtrate again with urea solution to form a TOFA-urea complex as a filter cake (precipitate) and a filtrate;
separating filtrate from the filter cake;
rewashing the filtrate with acidic water to recover di-fatty acids and rosins; and
reprocessing the filter cake to recover mono-unsaturated fatty acids.

12. The process of claim 11, wherein the TOFA mixture comprises a crude tall oil mixture or a distilled tall oil (DTO) mixture.

13. The process of claim 11, wherein the components of TOFA mixture are saturated fatty acids, mono-unsaturated fatty acids, bi-unsaturated fatty acids and rosins.

14. The process of claim 11, wherein at least one of:
the saturated fatty acids are at least one of stearic acid, palmitic acid, or a combination thereof;
the unsaturated fatty acids are at least one of oleic acid, non-conjugated linoleic acid, Conjugated-linoleic acid, or a combination thereof; or
combinations thereof.

15. The process of claim 11, wherein at least one of:
saturated fatty acids are separated from mono-unsaturated, bi-unsaturated fatty acids and poly-unsaturated fatty acids;
saturated fatty acids, mono-unsaturated fatty acids and poly-unsaturated acids are removed sequentially;
tall oil fatty acids are separated from rosins;
urea is recovered from the aqueous phase for reuse; or combinations thereof.

16. The process of claim 11, wherein acetonitrile and alcohol are in a ratio from about 1:10 to about 10:1 and urea to solvent ratio from about 1:1 to about 1:10.

17. The process of claim 11, wherein urea to TOFA ratio is about 10:1 to about 0.5:1.

18. The process of claim 11, wherein urea to TOFA ratio is about 4:1 to about 2:1.

19. The process of claim 11, wherein urea solution is prepared by heating at a temperature of 50-70° C.

20. The process of claim 11, wherein the alcohol is at least one of methanol, ethanol, isopropanol or a combination thereof.
